(19) United States
(12) Patent Application Publication
(10) Pub. No.: US 2017/0323251 A1
(43) Pub. Date: Nov. 9, 2017

(54) SYSTEMS AND METHODS FOR IDENTIFYING AND MANAGING ITEM STOCKING STATUS IN A RETAIL ENVIRONMENT

(71) Applicant: Wal-Mart Stores, Inc., Benlonville, AR (US)

(72) Inventors: Brian BODE, Bentonville, AR (US); John THOMPSON, Bentonville, AR (US)

(21) Appl. No.: 15/583,241

(22) Filed: May 1, 2017

Related U.S. Application Data
(60) Provisional application No. 62/332,212, filed on May 5, 2016.

(51) Int. Cl. G06Q 10/08; G06K 7/14; G06K 19/06; G06Q 30/06

(52) U.S. Cl. CPC G06Q 10/087; G06Q 30/0635; G06K 7/1413; G06K 19/06028

(57) ABSTRACT

Embodiments relate to systems and methods for identifying out-of-stock situations based on customer shopping lists and patterns. A system for identifying out-of-stock situations can comprise an electronic shopping list, an inventory database, and a stocking status engine communicatively coupled with the electronic shopping list and the inventory database and configured to analyze the electronic shopping list and the inventory database to identify a stocking status of at least one item on the electronic shopping list in a retail environment. If a potential out-of-stock event is identified, the system can output a stocking personnel notification to either replenish stock of the item in the retail environment or relocate existing stock of the item to a new location in the retail environment.

### RELATED APPLICATION

The present application claims the benefit of U.S. Provisional Application No. 62/332,212 filed May 5, 2016, which is incorporated herein by reference in its entirety.

### TECHNICAL FIELD

Embodiments relate generally to inventory management and more particularly to systems and methods for identifying out-of-stock situations based on customer shopping lists and patterns.

### BACKGROUND

Out-of-stock situations in retail stores result in lost sales and dissatisfied customers. Out-of-stock situations can result from selling out of an item or not relocating existing inventory from a storeroom to the sales floor. Customers also may perceive out-of-stock situations if they cannot locate an item, which can happen if the item has been relocated on the sales floor or they expected to find an item in one place without realizing it is stocked somewhere else. Because of the impact on sales and customer satisfaction, retailers want to identify and remedy out-of-stock situations quickly.

Conventional approaches rely on sales associates to visually identify out-of-stock events or reconciliation of periodic sales data with inventory data. The former can be inefficient while the latter can result in delays, as many stores reconcile the data only daily.

### SUMMARY

In an embodiment, a system for identifying and managing item stocking status in a retail environment comprises an electronic shopping list formulated by a customer and including at least one desired item; an inventory database of a retail environment; and a stocking status engine communicatively coupled with the electronic shopping list and the inventory database and configured to analyze the electronic shopping list and the inventory database in response to a customer activity related to the at least one desired item in the retail environment to identify a stocking status of the at least one desired item in the retail environment and output a stocking personnel notification to either (i) replenish stock of the at least one desired item at a designated location in the retail environment, or (ii) relocate existing stock of the at least one desired item to a new location in the retail environment.

In an embodiment, a method for identifying and managing item stocking status in a retail environment comprises receiving an electronic shopping list formulated by a customer and including at least one desired item; detecting occurrence of a customer activity related to the at least one desired item in a retail environment; identifying a stocking status of the at least one desired item in the retail environment by analyzing the electronic shopping list and an inventory database of the retail environment in response to the detecting; and providing a stocking personnel notification as a result of the identifying to either (i) replenish stock of the at least one desired item at a designated location in the retail environment, or (ii) relocate existing stock of the at least one desired item to a new location in the retail environment.

### BRIEF DESCRIPTION OF THE DRAWINGS

Embodiments may be more completely understood in consideration of the following detailed description of various embodiments in connection with the accompanying drawings, in which:

FIG. 1 is a block diagram of a system for identifying and managing stocking status according to an embodiment.

FIG. 2 is flowchart of a method related to the system of FIG. 1, according to an embodiment.

FIG. 3 is a diagram of a customer path in a retail environment according to an embodiment.

While embodiments are amenable to various modifications and alternative forms, specifics thereof have been shown by way of example in the drawings and will be described in detail. It should be understood, however, that the intention is not to be limited to the particular embodiments described. On the contrary, the intention is to cover all modifications, equivalents, and alternatives falling within the spirit and scope of the appended claims.

### DETAILED DESCRIPTION

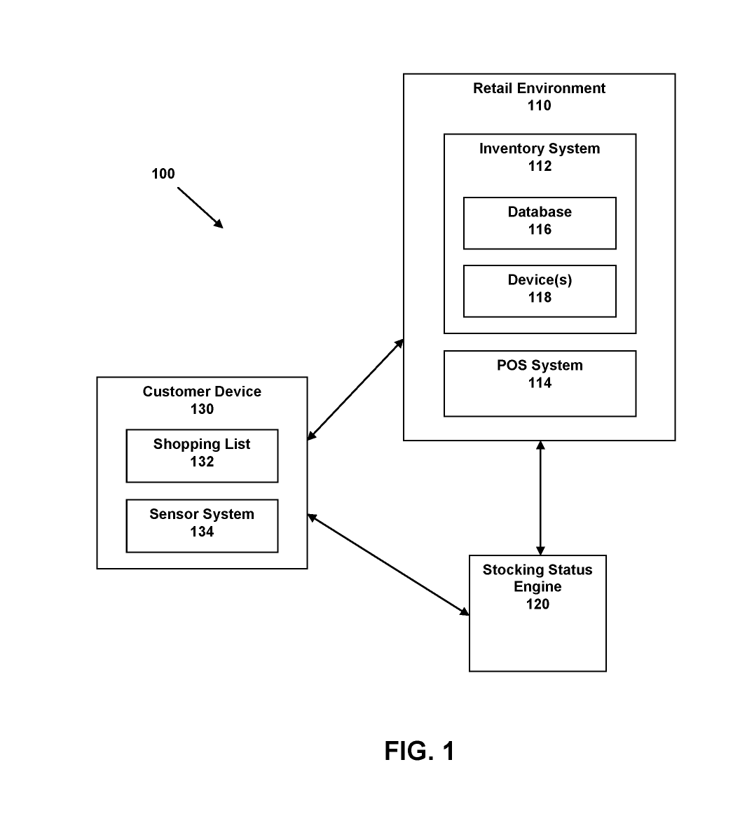

Referring to FIG. 1, an embodiment of a system 100 for identifying and managing stocking status is depicted. System 100 comprises a retail environment 110, a stocking status engine 120 and at least one customer device 130.

Retail environment 110 can be virtually any retail outlet, including a physical, brick-and-mortar storefront, an internet-based outlet, a hybrid of the two, or some other setting or location via which a customer may purchase or obtain products. FIG. 1 depicts only a single retail environment 110, but in many cases system 100 includes a plurality of retail environments 110. In one embodiment, system 100 comprises a plurality of retail environments 110, with some of the plurality of retail environments 110 being brick-and-mortar storefronts and at least one of the plurality of retail environments 110 being an internet-based website store.

Retail environment 110 can be associated with a retailer, such as by being a subsidiary, franchise, owned outlet, or other affiliate of the retailer. The retailer can be or have a home office or headquarters of a company, or some other affiliate, and often is located apart from retail environment 110. In some embodiments, facilities or functions associated with the broader retailer can be partially or fully co-located with retail environment 110. For example, the retailer can host some or all of an internet-based website retail environment 110. In another example, the retailer and a brick-and-mortar retail environment 110 can be co-located.

Retail environment 110 comprises an inventory system 112 and a point-of-sale (POS) system 114 in embodiments. Inventory system 112 and POS system 114 can be communicatively coupled and/or partially or fully integrated in embodiments, and either or both can be partially or fully integrated with other systems of retail environment 110 and/or a retailer. In still other embodiments, inventory system 112 can be updated based at least in part on information from POS system 114.

Inventory system 112 comprises a list or record of the inventory of retail environment 110, stored in an inventory database 116. Inventory database 116 can reside on a computer, server or other computing device at retail environment 110 or remote from retail environment 110. Inventory database 116 can be kept current in real time or updated periodically according to the practices of retail environment 110 (e.g., hourly, daily, etc.) and generally comprises a list or record of each item offered for sale in retail environment 110, the number of those items on-hand and currently in stock at retail environment 110, and other information (e.g., sales history, price, stock replenishment information, sales floor and/or stockroom location, etc.).

Inventory database 116 also can interface with, comprise or form a part of a system used to accept and document new product inventory at retail environment 110 so that new items and stock levels are added to inventory database 116 in real time or periodically. Such a system can comprise one or more devices 118 used to enter data (e.g., by scanning bar codes) into inventory system 112. Device(s) 118 can comprise handheld or other portable computing devices, such as tablets, smartphones, scanners, laptops, computers, and/or dedicated computing devices or workstations, used by sales associates or other employees, on the sales floor or in a storeroom, to locate and check on inventory and stock levels. In embodiments, device(s) 118 can receive information, including alerts. For example, an alert can be sent to device 118 associated with a department sales associate if it is determined that an item in their department needs to be restocked or otherwise attended to.

POS system 114 generally comprises the cash register systems, typically comprising computers and bar code or other scanning systems, used to check out customer purchases, accept payment, and handle returns and other customer transactions. In embodiments, POS system 114 can communicate with or otherwise share information with inventory system 112, which can enable inventory system 112 to be updated in real time or periodically as customers make purchases and inventory levels change accordingly in retail environment 110. Device(s) 118 also can interface with or comprise part of POS system 114.

In embodiments, stocking status engine 120 is associated with the retailer. Thus, stocking status engine can be located at a retailer (e.g., at a home office or headquarters) or otherwise affiliated with a retailer such that stocking status engine serves a plurality of retail environments 110 of the retailer. In other embodiments, stocking status engine 120 or components thereof can be located at one of a plurality of retail environments 110 (and can be communicatively coupled with and/or partially or fully integrated with one or both of inventory database 112 and POS system 114 in embodiments), or stocking status engine 120 can be physically remote from all retail environments 110 and retailer. Regardless of relative physical locations, stocking status engine 120 is communicatively coupled with both retail environment 110 and customer device 130 to facilitate the exchange of data and information and carry out activities in accordance with embodiments discussed herein.

Customer device 130 is associated with a customer. One customer device 130 is depicted in FIG. 1, but in embodiments system 100 can comprise or interface with a plurality of customer devices 130, including thousands or millions of customer devices 130 that interact with system 100. Customer device 130 can comprise a computer, a laptop, a tablet, a smartphone, a wearable computing device, or some other computing device via which a customer can send or receive information in system 100.

In embodiments, a user uses customer device 130 to formulate and manage an electronic shopping list 132. In an example embodiment that will be used herein, customer device 130 comprises a smartphone loaded with a mobile application (or “app”) configured to interface with retail environment 110 and stocking status engine 120. The app can be associated with the retailer of retail environment 110 (e.g., be a proprietary app of the retailer or retail environment 110) or it can be another app configured to and/or capable of sharing information with retail environment 110 and stocking status engine 120. For example, various shopping list apps are available for use in a variety of operating systems and that enable users to formulate and update shopping lists for groceries, household goods, and other items. Some of these apps are affiliated with particular retailers or other companies, such as those promoting nutrition, weight-loss, lifestyle, or brands, while others are not. In another example, many smartphones and other devices comprise “notes” or “lists” apps that some users use to formulate and update shopping lists and other information. In still another embodiment, the shopping list can be created using another device or system and transferred, wired or wirelessly, to customer device 130. For example, some voice-activated virtual assistants can collect verbal additions and assemble them in a shopping list, or “smart” appliances can track items for purchase and communicate a list to customer device 130. In any of these examples and other possible ways of formulating and managing shopping list 132, cloud-based services and/or features can be used. In this way, shopping list 132 can be formulated on a first customer device 130 and communicated to a second customer device 130 via the cloud. Edits and updates to shopping list 132 (e.g., additions, deletions, notes, etc.) on first customer device 130 also can be communicated to second customer device 130 and/or other devices in system 100 via the cloud. Thus, an app operating on customer device 130 can take advantage of cloud-based features and services to present shopping list 132 and otherwise operate. Regardless of the particular app and/or software used to host the list, customer device 130 generally comprises electronic shopping list 132 in embodiments, in that customer device 130 presents shopping list 132 for formulating, editing/updating, and viewing.

Customer device 130 can comprise a sensor system 134 in embodiments. Sensor system 134 can comprise a geolocation sensor system in embodiments, such as a global positioning system (GPS) or other sensor or system that enables a location of host customer device 130 to be determined. The features of sensor system 134 can vary according to the type of customer device 130, user settings, provider features or other characteristics. For example, many smartphones offer geolocation functions and provide the user with the option of turning them on or off or adjusting their settings according to their preferences, usage and/or privacy concerns. Thus, in some embodiments sensor system 134 can be active if a user of customer device 130 has selected active location services (or has not deactivated these services, depending on the default settings of customer device 130 in some situations), or sensor system 134 can be passive, relying on a user to self-report a location of customer device 130. For example, the app hosting shopping list 132 can request or require a user to identify a location when they open the app or use it in some way.

In still other embodiments, other ways of detecting, determining or reporting the location of customer device 130 or the customer can be used. Customer device 130 or an app thereon can interact with social media apps (e.g., Facebook, Twitter, Instagram, Snapchat, Whatsapp, etc.) to enable a user to “check in” at a location, including retail environment, or a proprietary or other app can request or incentivize checking in or other methods of self-reporting or automatically determining a location of customer device 130. For example, an app may provide points, special offers, or other incentives if a user checks in at or enables the app to determine their location at retail environment 110 or other locations. In another embodiment, a location tracking system and related sensors can be implemented in retail environment 110

Many other possibilities may be implemented in other embodiments. A general purpose related to sensor system 134, however, can be to determine if a user, via customer device 130, is present at or in retail environment 110 or not when other events occur. In some embodiments, a further purpose can be to determine whether a user, via customer device 130, is present at or in another retail environment when other events occur. In still other embodiments, another purpose can be to determine particular locations visited by a user within retail environment 110.

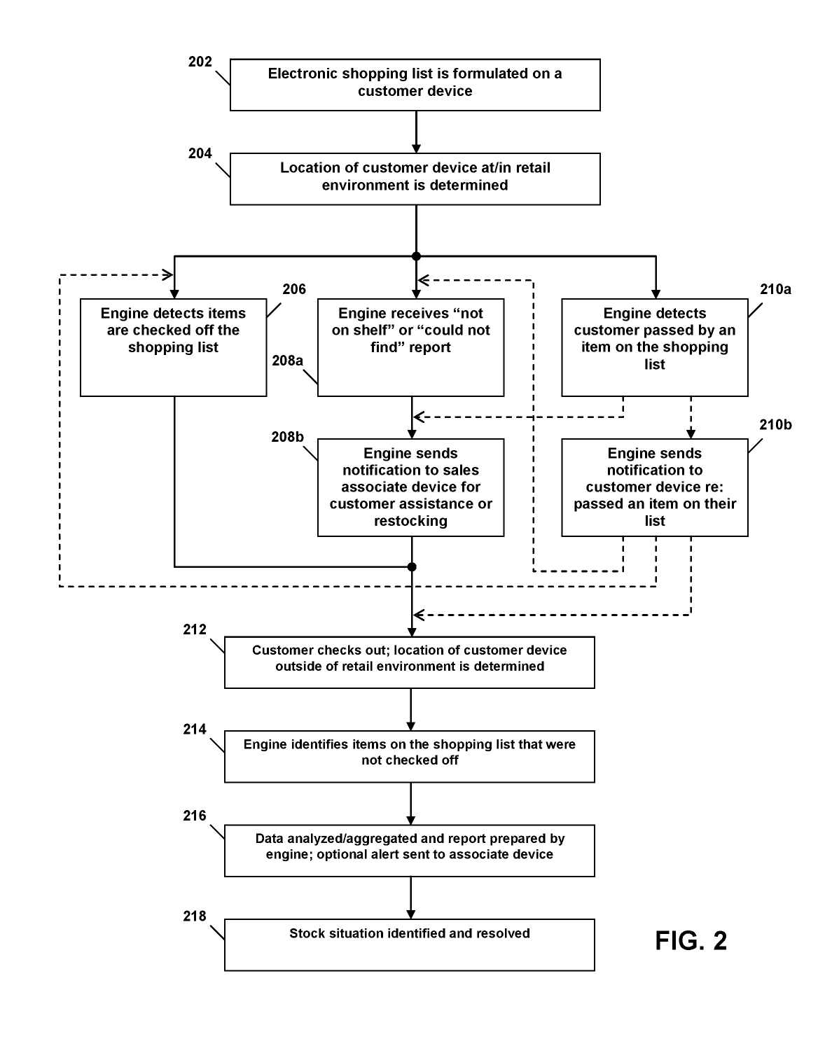

More particularly, in embodiments system 100 can be used to identify potential out-of-stock situations based on customer shopping lists and patterns. Referring also to FIG. 2, electronic shopping list 132 is formulated on a customer device at 202. As previously discussed, shopping list 132 can be formulated in a proprietary retailer app, a more general shopping list or other app, a “notes” or “lists” app, or in some other way via customer device 130.

At 204, system 100 detects or determines that customer device 130 is at or in retail environment 110. As previously discussed, this detecting or determining can be done in a variety of ways, including detecting a location of customer device 130 via sensor system 134, receiving an indication that a customer has “checked in” at retail location 110 via social media or an app, or in some other way. This detection or determination can be monitored in embodiments by stocking status engine 120.

Next, a variety of different tasks can occur or be carried, shown in FIG. 2 as 206; 208a and 208b; and 210a and 210b. In embodiments one or more of these tasks may occur as depicted, or in some other serial or parallel way; one or more of them may be repeated and in various orders, etc. In other words, FIG. 2 depicts examples of tasks that can occur in a simplified manner and for discussion purposes, but in operation any of these tasks may occur, in any order and any number of times.

At 206, system 100 detects that one or more items on shopping list 132 is/are checked off list 132, typically via activity on customer device 130 communicated to stocking status engine 120. Checking an item off list 132 while in retail location 110 generally can be interpreted to mean that a customer successfully located a desired item and selected it (i.e., removed the item from a shelf or display and placed it in a cart or basket, etc.) for purchase. In some embodiments, items checked off shopping list 132 can be correlated later with data from POS system 114 by stocking status engine 120 to confirm that a checked off item was in fact located and purchased.

In some instances, the customer may find that an item on shopping list 132 is out of stock. In other instances, the customer may not be able to locate a desired item. Thus, at 208a system 100 receives an alert or report from a customer that an item was not on the shelf or could not be located. In one embodiment, this can be done via customer device 130 sending a communication to stocking status engine 120, in particular in a retailer app that presents a user interface having a button, screen or other option for reporting an empty shelf or an item that cannot be found. In other embodiments, this information can be reported in system 100 in other ways, such as via an in-store kiosk having a computer terminal or phone system coupled with system 100 or by a report from a sales associate or cashier who interacts with the customer during their visit.

Upon receiving the alert or report, stocking status engine 120 can send a notification to device(s) 118 or otherwise alert a sales associate that an item potentially needs restocking (i.e., if the customer reports that the shelf was empty) or a customer needs assistance (i.e., if the customer reports that an item could not be located) at 208b. In embodiments in which sensor system 134 or some other device or system enables a customer location to be determined more precisely within retail location 110, the sales associate can be dispatched to the customer location to provide assistance. For example, the sales associate could locate the customer, confirm that the item is not on the shelf, check inventory (e.g., via device 118), and offer to get the item from the storeroom or other off-self inventory location if the item can be located. In another example, the customer may be looking for ketchup in an aisle with canned tomatoes and tomato sauces and report that ketchup cannot be found, and a sales associate dispatched to the aisle could redirect the customer to the aisle in which condiments are stocked. Alternatively, a retailer app on customer device 130 can detect or request information from the customer about what they are looking for and where, and the app, programmed with or having access to information about the precise layout of retail location 110, such as via stocking status engine 120, can provide information to help the customer locate the item (e.g., “Ketchup is located in aisle 6.”). Stocking status engine 120, in coordination with other components of system 100, can facilitate these and other actions at or after 208b in various embodiments.

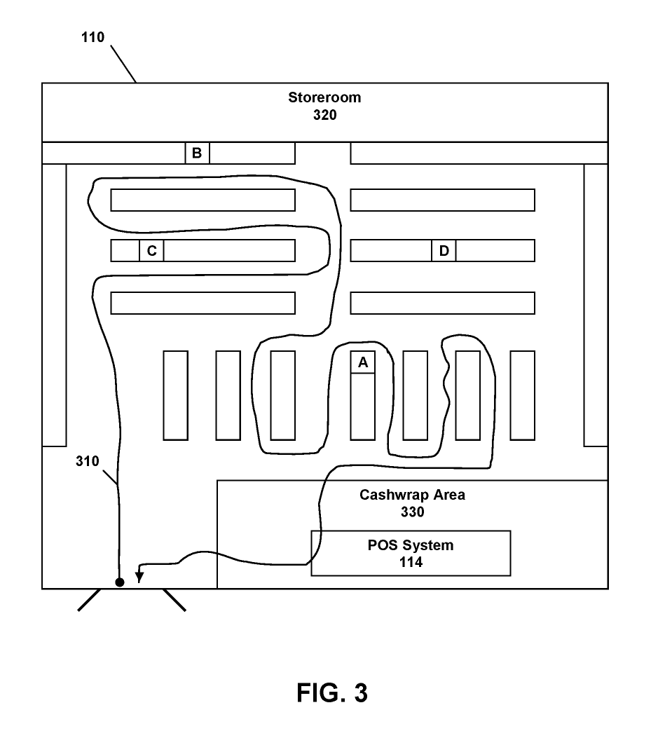

In embodiments in which a more precise location of customer device 130 within retail environment 110 can be determined or tracked, stocking status engine 120 can analyze a customer's path in retail environment 110 along with shopping list 132 and activity related thereto to determine potential out of stock situations. Referring also to FIG. 3, in embodiments sensor system 134 enables a customer's path 310 through retail environment 110 to be tracked or determined. Stocking status engine 120 can use this information along with shopping list 132, which in the example embodiment of FIG. 3 comprises items A, B, C and D. After entering retail environment, the customer first passes by the location of item C, then B, then A. From reviewing shopping list 132, stocking status engine 120 can determine that items B and A were checked off shopping list 132 during the time that the customer was in retail location 110.

Stocking status engine 120 also can determine, at 210a in FIG. 2, that the customer was near or passed by the location of item C but did not check item C off shopping list 132 before leaving retail location 110. This could be because item C was out of stock or because the customer did not see it. It also could be because the customer changed his/her mind about purchasing item C or for some other reason. Nevertheless, stocking status engine 120 can use this information to improve customer service.

For example, stocking status engine 120 can send a notification to customer device 130 to let the customer know that s/he just passed by item C on shopping list 132, at 210b in FIG. 2. This could occur while the customer is still in retail environment 110, giving the customer the opportunity to return for item C if s/he did not see it previously. In one embodiment, this can be done in real-time, or nearly so, so that the customer receives the notification while still near item C. If the customer did in fact pass by item C without finding it, then stocking status engine 120 may proceed from 210b to 206, subsequently detecting that the customer did check item C off shopping list 132 following the notification at 210b.

If the customer receives the notification at 210b but did not check item C off the list because item C was out of stock, the customer can respond to the notification by reporting (via customer device 130 to stocking status engine 120) that item C was not on the shelf, proceeding to 208a in FIG. 2. In one embodiment, the notification sent to customer device 130 that s/he passed by the location of item C can include a button or hyperlink for this purpose, making it easy for the customer to report the out of stock situation. Stocking status engine 120 can then alert a sales associate via device 118 at 208b, particularly if the customer reports at 208a, in response to the notification at 210b, that the item is out of stock, and stocking status engine 120 determines from inventory system 112 that item C is in stock elsewhere in retail environment 110, including in a stockroom or storeroom 320. In another embodiment, the notification at 210b can include an additional or alternate button or hyperlink for assistance, such that stocking status engine 120 proceeds to 208b. In a variation, stocking status engine 120 can proceed from 210a to 208b and send a notification to device 118 that a customer needs assistance or item C needs restocking without sending a customer notification. In one embodiment, the app or other settings on customer device 130 may indicate a “no notifications” preference, in which case stocking status engine 120 can default to alerting a sales associate to see if customers in the area of item C need assistance or if item C is in fact in need of restocking.

Regardless of the action(s) taken in system 100 in response to customer activity in any of 206, 208a, 208b, 210a and 210b, the customer eventually checks out at a cashwrap area 330 of retail environment 110 and leaves retail environment 110, at 212. Cashwrap area 330 includes computers, registers or stations of POS system 114, which can collect additional information about the items actually purchased by the customer. In one embodiment, this additional information can be used by stocking status engine 120 to make additional determinations related to shopping list 132, possible out of stock situations in retail environment 110, or other behaviors or characteristics related to the customer's shopping experience. In one embodiment, the customer can self-report that s/he is checking out and/or leaving retail environment 110 via customer device 130. In another embodiment, stocking status engine 120 can detect that customer device 130 is no longer in retail environment 110 via sensor system 134. In either situation and at this point, in one embodiment stocking status engine 120 can query the customer, via customer device 130, about why items were not checked off shopping list 132, which can provide additional information (e.g., item was out of stock; item could not be located; item was located but did not meet price, quality or other expectations, etc.) In some embodiments, detection or reporting of the customer leaving retail environment 110 triggers subsequent tasks (e.g., 214, 216, 218).

At 214, stocking status engine 120 identifies items on shopping list 132 that were not checked off. In the example related to FIG. 3, items C and D ultimately were not checked off shopping list 132.

At 216, stocking status engine 120 analyzes data related one or more customers and shopping lists 132 along with other data available in system 100. In one embodiment, stocking status engine 120 can analyze shopping list 132 and inventory database 116 in response to a customer activity in the retail environment to identify a stocking status of at least one item on shopping list 132. In another embodiment, stocking status engine 120 also can analyze one or both of inventory database 116 and path 310 along with shopping list 132. In yet another embodiment, stocking status engine 120 also can consider and analyze data received from POS system 114 when the customer checks out and makes their purchases. This information can be helpful to identify situations in which the customer did locate and ultimately purchase an item while simply forgetting to check the item off shopping list 132.

Thus, in the example related to FIG. 3, stocking status engine 120 can determine that item C may be out of stock and item D could not be found by the customer after analyzing data related to shopping list 132, inventory database 116 and customer path 310. Data related to a plurality of customers and shopping lists 132 associated with retail environment 110 can be aggregated and analyzed by stocking status engine 120. For example, stocking status engine 120 can determine that a significant percentage of customers (or a significant number of trips to retail environment 110) with item D on shopping list 132 did not check it off, which could mean that item D is out of stock or (more likely in the particular example illustrated in FIG. 3) not located in a place where customers expect to find it. Stocking status engine 120 also can check inventory database 116 to confirm that item D is, in fact, in stock in retail environment 110. Item D therefore could be a candidate for relocation within retail environment 110. In another example, periodic data (e.g., hourly, related to an employee shift, daily, weekly, etc.) can be aggregated by system 100, and system 100 can determine that high demand for item C during particular time periods leads to repeated “out of stock” situations, which could enable stocking and staffing decisions to be updated.

More generally, stocking status engine 120 can prepare a report of possible out-of-stock or other situations identified from shopping list 132, inventory database 116 and/or path 310 data. The report can be communicated to one or more sales associates, such as via device(s) 118, so that the associates can work through the list, restocking any items that were out of stock and removing those items from the list. In embodiments, stocking status engine 120 can rank items in the report from most likely to be out of stock to least likely, or according to some other criteria (e.g., high revenue generating, special offer, demand drivers, etc.). Stocking status engine 120 can determine probabilities and other factors for ranking based on the available data at 216, and probabilities can be updated as additional data becomes available to stocking status engine 120. Sales associates can report information back to stocking status engine 120 via device(s) 118 at 218, to report out of stock situations as resolved as well as for further use and analysis by stocking status engine 120 (e.g., confirming out of stock events, pattern identification, identifying items for which higher volumes should be stocked because they frequently are reported as out of stock, etc.). These and other activities by stocking status engine 120 enable proactive steps to be taken within retail environment 110 to, e.g., locate items in more convenient or expected areas, grouping items frequently purchased together, avoiding out of stock situations, etc., thereby improving customer experience. Stocking status engine 120 and system 100 thereby provide tangible results, including restocked shelves, item location and others as discussed herein.

In yet another embodiment, data related to shopping list 132 can be monitored or collected by system 100 when device 100 is not in retail environment 110. This can be helpful, for example, in situations in which stocking status engine 120 determines that a customer left retail environment 110 with items remaining on shopping list 132. If those items are later checked off and stocking status engine 120 does not locate customer device 130 within retail environment 110 at the time the items are checked off from the list, stocking status engine 120 can use this information as further confirmation of an out-of-stock event, given that the customer did ultimately purchase the item, and use this information at 216. As discussed above, customer privacy preferences can be taken into consideration, such that sensor system 134 may be disabled or the customer must “opt in” for various tracking features.

Embodiments therefore relate to inventory management and more particularly to systems and methods for identifying out-of-stock situations based on customer shopping lists and patterns. Various advantages and improvements over conventional approaches are provided, including faster results (e.g., quicker identification and tangible resolution of out-of-stock events by providing a desired item to a customer and/or more quickly restocking physical sales areas), improved accuracy, enhanced analytics provided by additional data points (e.g., shopping list, shopping path, etc.), avoidance of relying on manual visual assessment of stocking by sales associates, and avoidance of the expense and complexity of RFID or other conventional inventory tracking approaches, among others.

In embodiments, system 100 and/or its components or systems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In embodiments, the system or components thereof can comprise or include various modules or engines, each of which is constructed, programmed, configured, or otherwise adapted, to autonomously carry out a function or set of functions. The term “engine” as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A system for identifying and managing item stocking status in a retail environment comprising:
an electronic shopping list formulated by a customer and including at least one desired item;
an inventory database of a retail environment; and
a stocking status engine communicatively coupled with the electronic shopping list and the inventory database and configured to analyze the electronic shopping list and the inventory database in response to a customer activity related to the at least one desired item in the retail environment to identify a stocking status of the at least one desired item in the retail environment and output a stocking personnel notification to either (i) replenish stock of the at least one desired item at a designated location in the retail environment, or (ii) relocate existing stock of the at least one desired item to a new location in the retail environment.

2. The system of claim 1, further comprising at least one geolocation sensor system communicatively coupled to the stocking status engine and configured to identify a location of the customer at or within the retail environment.

3. The system of claim 2, wherein the customer activity related to the at least one desired item is the customer passing by the designated location of the at least one desired item, as identified by the at least one geolocation sensor system, without removing the at least one item from the electronic shopping list.

4. The system of claim 2, wherein the customer activity related to the at least one desired item is the customer leaving the retail environment, as identified by the at least one geolocation sensor system, without removing the at least one item from the electronic shopping list.

5. The system of claim 2, wherein the customer activity related to the at least one desired item is the customer removing the at least one item from the electronic shopping list when the customer is not at or within the retail environment.

6. The system of claim 2, wherein the at least one geolocation sensor system comprises at least one of a Global Positioning System (GPS) or an application operating on a customer smartphone, tablet or portable computing device that stores the electronic shopping list.

7. The system of claim 1, further comprising a point-of-sale (POS) system of the retail environment and communicatively coupled with the stocking status engine, wherein the stocking status engine is configured to analyze data received from the POS system, and wherein the customer activity related to the at least one desired item is the customer making a purchase at the POS system.

8. The system of claim 1, wherein the electronic shopping list is presented by an application configured to operate on at least one of a smartphone, a tablet device, or a portable computing device.

9. The system of claim 8, wherein the application comprises a graphical user interface configured to display the electronic shopping list and accept input from the customer.

10. The system of claim 9, wherein the input from the customer is a report that the desired item is out of stock at the designated location.

11. The system of claim 9, wherein the input from the customer is a report that the desired item could not be located in the retail environment.

12. The system of claim 9, wherein the input from the customer is the at least one desired item added to the electronic shopping list.

13. The system of claim 1, further comprising a portable computing device associated with the retail environment and configured to receive and output the stocking personnel notification.

14. The system of claim 1, wherein the stocking status engine is configured to correlate information related to a plurality of electronic shopping lists, associated with a plurality of customers, to more accurately identify the stocking status of the at least one desired item in the retail environment.

15. A method for identifying and managing item stocking status in a retail environment comprising:
receiving an electronic shopping list formulated by a customer and including at least one desired item;
detecting occurrence of a customer activity related to the at least one desired item in a retail environment;
identifying a stocking status of the at least one desired item in the retail environment by analyzing the electronic shopping list and an inventory database of the retail environment in response to the detecting; and
providing a stocking personnel notification as a result of the identifying to either
(i) replenish stock of the at least one desired item at a designated location in the retail environment, or
(ii) relocate existing stock of the at least one desired item to a new location in the retail environment.

16. The method of claim 15, further comprising:
identifying a location of the customer at or within the retail environment;
wherein detecting a customer activity further comprises detecting at least one of:
the customer passing by the designated location of the at least one desired item without removing the at least one item from the electronic shopping list,
the customer leaving the retail environment without removing the at least one item from the electronic shopping list, or
the customer removing the at least one item from the electronic shopping list when the customer is not at or within the retail environment.

17. The method of claim 15, further comprising:
receiving information from a point-of-sale (POS) system of the retail environment;
wherein detecting a customer activity further comprises detecting the customer making a purchase at the POS system, and
wherein identifying a stocking status of the at least one desired item further comprises analyzing the received information from the POS system.

18. The method of claim 15, further comprising receiving from the customer an electronic report that the desired item is either out of stock at the designated location or could not be located in the retail environment.

19. The method of claim 15, further comprising presenting an electronic application via which the customer can formulate the electronic shopping list.

20. The method of claim 15, further comprising receiving the stocking personnel notification by a portable computing device associated with the retail environment.

21. The method of claim 15, further comprising:
receiving a plurality of electronic shopping lists, each formulated by a customer and including at least one desired item; and
correlating information related to the plurality of electronic shopping lists to more accurately identify the stocking status of the at least one desired item in the retail environment.
